(19) United States
(12) Patent Application Publication
(10) Pub. No.: US 2025/0218331 A1
(43) Pub. Date: Jul. 3, 2025

(54) Method for adjusting output electrical signal of power management integrated circuit, screen driver board and electronic device

(71) Applicants: Analogix (Suzhou) Semiconductor Co., LTD., Suzhou, Jiangsu (CN); ANALOGIX INTERNATIONAL LLC, Delaware, DE (US)

(72) Inventor: Chuncheng GUO, Suzhou, Jiangsu (CN)

(21) Appl. No.: 18/031,150

(22) PCT Filed: Oct. 11, 2022
(86) PCT No.: PCT/CN2022/124666

§ 371 Date: Mar. 25, 2025

(30) Foreign Application Priority Data
Jul. 21, 2022 (CN) 202210867895.3

(51) Int. Cl. G09G 3/20

(52) U.S. Cl. CPC G09G 3/2092; G09G 2310/0289; G09G 2330/021

(57) ABSTRACT

Provided in the present disclosure are a method for adjusting an output electrical signal of a power management integrated circuit, and a screen driver board, and an electronic device. The method includes: acquiring display frame source data of frames displayed on a display module, and the display frame source data at least includes a pixel value of each pixel point; adjusting an output electrical signal of a Power Management Integrated Circuit (PMIC) according to the display frame source data. The output electrical signal is used for supplying power for a screen-related structure; and the screen-related structure includes at least one of a screen driver board, a light-emitting structure and a level shifter chip. By means of acquiring the display frame source data of the frames displayed on the display module, and then adjusting the output electrical signal of the PMIC according to the display frame source data, the adaptability of the output electrical signal of the PMIC can be adjusted. Compared with a solution of outputting a fixed electrical signal, power consumption can be reduced.

The present disclosure is based upon and claims priority to Chinese Patent Application No. 2022108678953, filed to the China National Intellectual Property Administration on Jul. 21, 2022, and entitled “Method for Adjusting Output Electrical Signal of Power Management Integrated Circuit, and Screen Driver Board”, the disclosure of which is hereby incorporated by reference in its entirety.

### TECHNICAL FIELD

The present disclosure relates to the field of display devices, and specifically, to a method for adjusting an output electrical signal of a power management integrated circuit, and a screen driver board, and an electronic device.

### BACKGROUND

A common display screen mainly includes a Timing Controller (TCON, a screen driver board), a level shifter chip, and a Power Management Integrated Circuit (PMIC). In a practical application, the PMIC provides, according to the power requirement of each structure, a fixed voltage or current to other structures for use, so as to ensure that the fixed voltage or current may meet application under heavy loading. Under this solution, power consumption is in a relatively-stable state.

However, in the practical application, the display screen does not operate in high loading mode all the time, which causes a waste of power consumption.

### SUMMARY

The present disclosure is mainly intended to provide a method for adjusting an output electrical signal of a power management integrated circuit, and a screen driver board, and an electronic device, to solve the problem in the related art that the PMIC provides a fixed voltage or current to other structures, resulting in waste of power consumption.

In order to implement the above objective, an aspect of the present disclosure provides the method for adjusting the output electrical signal of the power management integrated circuit. The method includes: display frame source data of frames displayed on a display module is acquired, and the display frame source data at least includes a pixel value of each pixel point; an output electrical signal of a Power Management Integrated Circuit (PMIC) is adjusted according to the display frame source data. The output electrical signal is used for supplying power for a screen-related structure; and the screen-related structure includes at least one of a screen driver board, a light-emitting structure and a level shifter chip.

Optionally, the operation of the output electrical signal of the PMIC is adjusted according to the display frame source data includes: in a case of the pixel values of all of the pixel points are the same pixel value, the output electrical signal of the PMIC is adjusted according to the pixel value; and in a case of the pixel values of all of the pixel points are not the same pixel value, the output electrical signal is adjusted of the PMIC according to the difference among the different pixel values.

Optionally, the operation of in a case of the pixel values of all of the pixel points are the same pixel value, the output electrical signal of the PMIC is adjusted according to the pixel value includes at least one of the following: in a case of the pixel values of all of the pixel points are minimum pixel values, the output electrical signal to a first output electrical signal is adjusted; in a case of the pixel values of all of the pixel points are maximum pixel values, the output electrical signal to a second output electrical signal is adjusted; or in a case of the pixel values of all of the pixel points are intermediate pixel values, the output electrical signal to a third output electrical signal is adjusted. The intermediate pixel values are greater than the minimum pixel value and less than the maximum pixel value. The first output electrical signal is less than the third output electrical signal. The third output electrical signal is less than the second output electrical signal.

Optionally, the operation of in a case of the pixel values of all of the pixel points are not the same pixel value, the output electrical signal of the PMIC is adjusted according to the difference among the different pixel values includes at least one of the following: in a case of the pixel values of two adjacent display rows are successively first pixel values and second pixel values, the output electrical signal of the PMIC is adjusted to a first drive electrical signal in a case of a first display row is driven, and the output electrical signal of the PMIC is adjusted to a second drive electrical signal in a case of a second display row is driven, where the pixel values of the pixel points in the first display row are the first pixel values, and the pixel values of the pixel points in the second display row are the second pixel values; and in a case of the pixel values of two adjacent pixel points in the same display row respectively are the first pixel value and the second pixel value, the first drive electrical signal and the second drive electrical signal are alternately used to drive the two adjacent pixel points in the same display row.

Optionally, each pixel point includes a plurality of sub-pixel points; and the operation of the output electrical signal of the PMIC is adjusted according to the display frame source data includes: the output electrical signal of the PMIC is adjusted according to the pixel values of the sub-pixel points in each pixel point.

Optionally, the operation of the output electrical signal of the PMIC is adjusted according to the pixel values of the sub-pixel points in each pixel point includes: in a case of the pixel values of the two adjacent sub-pixel points in the same display row respectively are a first pixel value and a second pixel value, a first drive electrical signal and a second drive electrical signal are alternately used to drive the two adjacent sub-pixel points in the same display row.

Optionally, the operation of in a case of the pixel values of the two adjacent sub-pixel points in the same display row respectively are the first pixel value and the second pixel value, the first drive electrical signal and the second drive electrical signal are alternately used to drive the two adjacent sub-pixel points in the same display row includes: in a case of the pixel values of the two adjacent sub-pixel points in the same display row respectively are the first pixel value and the second pixel value and the pixel values of the plurality of sub-pixel points in the same display column are the first pixel values or the second pixel values, the first drive electrical signal and the second drive electrical signal are alternately to drive the two adjacent sub-pixel points in the same display row, and the sequence of driving the first drive electrical signal and the second drive electrical signal of all the display rows is the same; and in a case of the pixel values of the two adjacent sub-pixel points in the same display row respectively are the first pixel value and the second pixel value and the pixel values of the two adjacent sub-pixel points in the same display column respectively are the first pixel value and the second pixel value, the first drive electrical signal and the second drive electrical signal are alternately used to drive the two adjacent sub-pixel points in the same display row. The sequence of driving the first drive electrical signals and the second drive electrical signals of two adjacent display rows is different.

Optionally, one pixel point includes three sub-pixel points.

Optionally, the output electrical signal is a voltage signal or a current signal.

Another aspect of the present disclosure provides a screen driver board. The screen driver board includes: an acquisition component, configured to acquire display frame source data of frames displayed on a display module, and the display frame source data at least comprises a pixel value of each pixel point; and an adjustment component, configured to adjust an output electrical signal of a PMIC according to the display frame source data. The output electrical signal is used for supplying power for a screen-related structure. The screen-related structure includes at least one of a screen driver board, a light-emitting structure and a level shifter chip.

Still another aspect of the present disclosure provides an electronic device. The electronic device includes one or more processors, a memory, and one or more programs. The one or more programs are stored in the memory, and are configured to be executed by the one or more processors. The one or more programs instructions that are configured to execute the method described in any one of the above.

Through the application of the technical solutions of the present disclosure, by means of acquiring the display frame source data of the frames displayed on the display module, and then adjusting the output electrical signal of the PMIC according to the display frame source data, the adaptability of the output electrical signal of the PMIC can be adjusted. Compared with a solution of outputting a fixed electrical signal, power consumption can be reduced.

### BRIEF DESCRIPTION OF THE DRAWINGS

The accompanying drawings constituting a part of the present disclosure are used to provide a further understanding of the present disclosure. The exemplary embodiments of the present disclosure and the description thereof are used to explain the present disclosure, but do not constitute improper limitations to the present disclosure. In the drawings:

FIG. 1 is a flowchart of a method for adjusting an output electrical signal of a power management integrated circuit according to an embodiment of the present disclosure.

FIG. 2 is a schematic diagram of a display device according to an embodiment of the present disclosure.

FIG. 3 is a schematic diagram of a power distribution solution according to an embodiment of the present disclosure.

FIG. 4 is a schematic diagram of a screen driver board according to an embodiment of the present disclosure.

### DETAILED DESCRIPTION OF THE EMBODIMENTS

It is to be noted that the embodiments in the present disclosure and the features in the embodiments may be combined with one another without conflict. The present disclosure will be described below in detail with reference to the drawings and the embodiments.

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skill in the art without creative work shall all fall within the protection scope of the present disclosure.

It is to be noted that terms “first”, “second” and the like in the description, claims and the above-mentioned drawings of the present disclosure are used for distinguishing similar objects rather than describing a specific sequence or a precedence order. It should be understood that the data used in such a way may be exchanged where appropriate, in order that the embodiments of the invention described here can be implemented. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

It should be understood that, in a case of an element (such as a layer, a film, a region, or a substrate) is described as being “on” another element, the element may be directly on that other element, or there may be an intermediate element. In addition, in the description and the claims, in a case of an element is described as “connected” to another element, the element may be “directly connected” to the other element or “connected” to the other element via a third element.

For ease of description, part of the nouns or terms involved in embodiments of the present disclosure are described below.

TCON (screen driver board): which is a central control panel, and plays a role of processing, by means of the central control panel, an LVDS image data input signal (the input signal including an RGB data signal, a clock signal and a control signal) sent by a digital board, then converting the input signal into an LVDS signal that can drive a liquid crystal display, and then directly sending the LVDS signal to an LVDS receiving chip of the liquid crystal display. A shifting register is processed for storage; an image data signal and the clock signal are converted into control signals that can be identified by a screen; a row-column signal RSDS controls the operation of an MOSFET tube in the screen to control the distortion of liquid crystal molecules, so as to drive the liquid crystal display to display an image. A logic board is an assembly having software and inherent programs.

PMIC is a chip that is responsible for the distribution, detection and other electrical energy management in an electronic system, which is mainly responsible for identifying a CPU power supply amplitude, generating a corresponding short-range wave, and promoting a post-stage circuit for power output. Common PMICs include LMG3410R050, UCC12050, BQ25790, IS6537 and the like.

GATE TIMING refers to a timing gate.

Graphic Output Protocol (GOP) is used to extend an image driver to an interface of UEFI firmware, so as to replace initialization behaviors of traditional VBIOS (Video BIOS), such as startup resource requirements.

VCOM refers to common voltage; and a TFT needs the common voltage to cooperate with a pixel voltage, so as to drive the liquid crystal display to display the image.

AVDD simulates a circuit power.

SRIC receives an interrupt controller, which plays a role that an event stops to execute a current program, but to execute other programs, and returns to execute the interrupted program after execution.

As described in the Background, in the related art, in order to ensure that a fixed voltage or current may meet application under heavy loading, the fixed voltage or current that can meet heavy loading operation is generally directly provided to the display module. However, the high voltage or current is not required during low loading operation, resulting in waste of power consumption due to such manner of only providing the fixed voltage or current.

An embodiment of the present disclosure provides a method for adjusting an output electrical signal of a power management integrated circuit.

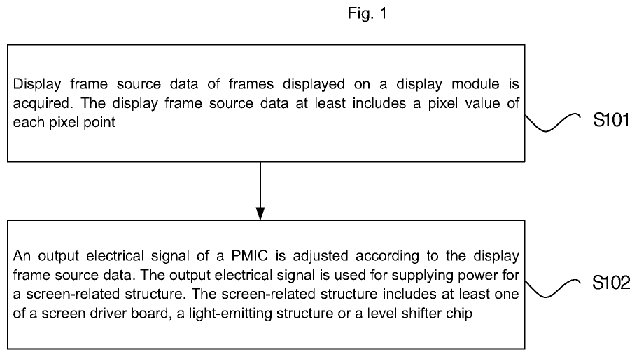

FIG. 1 is a flowchart of the method for adjusting the output electrical signal of the power management integrated circuit according to some embodiments of the present disclosure. As shown in FIG. 1, the method includes the following steps.

At S101, display frame source data of frames displayed on a display module is acquired. The display frame source data at least includes a pixel value of each pixel point.

The display frame source data refers to data that may display a target frame on the display module. After the display frame source data is converted into the data that may drive the display module, the target frame can be displayed on the display module.

Specifically, the display module may be a display screen, and may specifically be an LCD screen or an LED display screen.

At S102, an output electrical signal of a PMIC is adjusted according to the display frame source data. The output electrical signal is used for supplying power for a screen-related structure. The screen-related structure includes at least one of a screen driver board, a light-emitting structure and a level shifter chip.

In a practical application, the PMIC provides a supply power for structures such as the screen driver board, the light-emitting structure and the level shifter chip. Definitely, the supply voltages of different structures may be the same or different.

In this solution, by means of acquiring the display frame source data of the frames displayed on the display module, and then adjusting the output electrical signal of the PMIC according to the display frame source data, the adaptability of the output electrical signal of the PMIC can be adjusted. Compared with a solution of outputting a fixed electrical signal, power consumption can be reduced.

It is to be noted that the steps shown in the flow diagram of the accompanying drawings may be executed in a computer system, such as a set of computer-executable instructions, and although a logical sequence is shown in the flow diagram, in some cases, the steps shown or described may be executed in a different order than here.

In some embodiments of the present disclosure, the step of the output electrical signal of the PMIC is adjusted according to the display frame source data includes: in a case of the pixel values of all of the pixel points are the same pixel value the output electrical signal of the PMIC is adjusted according to the pixel value; and in a case of the pixel values of all of the pixel points are not the same pixel value, according to the difference among the different pixel values, the output electrical signal of the PMIC is adjusted. That is to say, the output electrical signal of the PMIC is adjusted according to numerical value of the pixel value and changes in the pixel values. Therefore, insofar as guaranteeing a display effect, power consumption can be reduced.

Specifically, in a case of the pixel values of all of the pixel points are the same pixel value, according to the pixel value, at least one of a power supply of the screen driver board, a power supply of a source driver chip or a power supply of the level shifter chip in FIG. 3 is adjusted. In a case of the pixel values of all of the pixel points are not the same pixel value, according to the difference among the different pixel values, at least one of the power supplies of the screen driver board, the power supply of the source driver chip or the power supply of the level shifter chip in FIG. 3 is adjusted. It is mainly to adjust the power supply of the source driver chip, so as to, insofar as guaranteeing a display effect, save energy.

In addition, according to the pixel values of the sub-pixel points, a voltage signal or a current signal of the power supply of the screen driver board in FIG. 3 is adjusted, so as to ensure that the power of the power signal of the screen driver board matches the pixel values of the sub-pixel points.

In addition, according to the pixel values of the sub-pixel points, a voltage signal or a current signal of the power supply of the level shifter chip in FIG. 3 is adjusted, so as to ensure that the power of the level shifter chip matches the pixel values of the sub-pixel points.

In some other embodiments of the present disclosure, the step of in a case of the pixel values of all of the pixel points are the same pixel value, according to the pixel value, the output electrical signal of the PMIC is adjusted includes at least one of the following: in a case of the pixel values of all of the pixel points are minimum pixel values, the output electrical signal is adjusted to a first output electrical signal; in a case of the pixel values of all of the pixel points are maximum pixel values, the output electrical signal is adjusted to a second output electrical signal; or in a case of the pixel values of all of the pixel points are intermediate pixel values, the output electrical signal is adjusted to a third output electrical signal. The intermediate pixel values are greater than the minimum pixel value and less than the maximum pixel value. The first output electrical signal is less than the third output electrical signal. The third output electrical signal is less than the second output electrical signal. For example, in a case of all of the pixel points are displayed in black, all of the pixel values are the minimum pixel values 0, and in this case, the display effect can be achieved by outputting a small first output electrical signal. In a case of all of the pixel points are displayed in white, all of the pixel values are the minimum pixel values 255, and in this case, the display effect can be achieved by outputting a large second output electrical signal. In a case of all of the pixel points are displayed in gray, all of the pixel values are the intermediate pixel values 100, and in this case, the display effect can be achieved by outputting an intermediate third output electrical signal. In conclusion, insofar as meeting the display effect, power consumption can be reduced.

Specifically, in a case of all of the pixel points are displayed in black, the small first output electrical signal is outputted, and the energy consumed accounts for about 20% of the maximum energy consumption. In a case of all of the pixel points are displayed in white, the large second output electrical signal is outputted, and the energy consumed accounts for about 70% of the maximum energy consumption. In a case of all of the pixel points are displayed in gray, the energy consumed accounts for about 50% of the maximum energy consumption. That is to say, power consumption is reduced.

In some other embodiments of the present disclosure, the step of in a case of the pixel values of all of the pixel points are not the same pixel value, according to the difference among the different pixel values, the output electrical signal of the PMIC is adjusted includes at least one of the following: in a case of the pixel values of two adjacent display rows are successively first pixel values and second pixel values, the output electrical signal of the PMIC is adjusted to a first drive electrical signal in a case of a first display row is driven, and the output electrical signal of the PMIC is adjusted to a second drive electrical signal in a case of a second display row is driven, where the pixel values of the pixel points in the first display row are the first pixel values, and the pixel values of the pixel points in the second display row are the second pixel values, for example, in a case of a row of black and a row of white are alternately displayed, the first drive electrical signal is used in a case of the black display row is driven, the second drive electrical signal is used in a case of the white display row is driven, and since the first drive electrical signal is different from the second drive electrical signal, level shifting is required to be performed; and in a case of the pixel values of two adjacent pixel points in the same display row respectively are the first pixel value and the second pixel value, alternately using the first drive electrical signal and the second drive electrical signal to drive the two adjacent pixel points in the same display row. For example, in a case of the same display row is displayed in black and white alternately, the first drive electrical signal is used in a case of the displayed black pixel points are driven, and the second drive electrical signal is used in a case of the displayed white pixel points are driven. Since the first drive electrical signal is different from the second drive electrical signal, level shifting is required to be performed Definitely, the solutions in this embodiment are merely exemplary. That the pixel values of all of the pixel points are not the same pixel value may further include the following situations. The first two adjacent rows in the four rows are displayed as the first pixel values, and the last two adjacent rows are displayed as the second pixel value; the first three adjacent rows in the six rows are displayed as the first pixel values, and the last three adjacent rows are displayed as the second pixel value; and so on. Details are not enumerated herein.

Specifically, in a case of the pixel values of two adjacent display rows are successively first pixel values and second pixel values, the energy consumed accounts for about 75% of the maximum energy consumption; and in a case of the pixel values of two adjacent pixel points in the same display row respectively are the first pixel value and the second pixel value, the energy consumed accounts for about 80% of the maximum energy consumption. Therefore, power consumption is also reduced.

In some other embodiments of the present disclosure, each pixel point includes a plurality of sub-pixel points; and the step of the output electrical signal of the PMIC is adjusted according to the display frame source data includes: the output electrical signal of the PMIC is adjusted according to the pixel values of the sub-pixel points in each pixel point. In order to adjust the output electrical signal of the PMIC more accurately, a parameter of sub-pixel point is taken into consideration.

In some other embodiments of the present disclosure, the step of the output electrical signal of the PMIC is adjusted according to the pixel values of the sub-pixel points in each pixel point includes: in a case of the pixel values of the two adjacent sub-pixel points in the same display row respectively are a first pixel value and a second pixel value, a first drive electrical signal and a second drive electrical signal are alternately used to drive the two adjacent sub-pixel points in the same display row. Therefore, insofar as guaranteeing the same display effect, power consumption can be reduced. Definitely, the solutions in this embodiment are merely exemplary. The first two of the three sub-pixel points are the first pixel values, and the last one is the second pixel value; the first one of the three sub-pixel points is the first pixel value, and the last two are the second pixel values; and so on. The above situations are all fall within the scope of protection of the present disclosure, which are not enumerated herein.

Specifically, according to the pixel values of the sub-pixel points in each pixel point, at least one of the power supply of the screen driver board, the power supply of the source driver chip or the power supply of the level shifter chip in FIG. 3 is adjusted. It is mainly to adjust the power supply of the source driver chip, so as to, insofar as guaranteeing a display effect, save energy.

In addition, according to the pixel values of the sub-pixel points, a voltage signal or a current signal of the power supply of the screen driver board in FIG. 3 is adjusted, so as to ensure that the power of the power signal of the screen driver board matches the pixel values of the sub-pixel points.

In addition, according to the pixel values of the sub-pixel points, a voltage signal or a current signal of the power supply of the level shifter chip in FIG. 3 is adjusted, so as to ensure that the power of the level shifter chip matches the pixel values of the sub-pixel points.

In some other embodiments of the present disclosure, the step of in a case of the pixel values of the two adjacent sub-pixel points in the same display row respectively are the first pixel value and the second pixel value, the first drive electrical signal and the second drive electrical signal are alternately used to drive the two adjacent sub-pixel points in the same display row includes: in a case of the pixel values of the two adjacent sub-pixel points in the same display row respectively are the first pixel value and the second pixel value and the pixel values of the plurality of sub-pixel points in the same display column are the first pixel values or the second pixel values, the first drive electrical signal and the second drive electrical signal are alternately used to drive the two adjacent sub-pixel points in the same display row, and the sequence of driving the first drive electrical signal and the second drive electrical signal of all the display rows is the same; and in a case of the pixel values of the two adjacent sub-pixel points in the same display row respectively are the first pixel value and the second pixel value and the pixel values of the two adjacent sub-pixel points in the same display column respectively are the first pixel value and the second pixel value, the first drive electrical signal and the second drive electrical signal are alternately used to drive the two adjacent sub-pixel points in the same display row. The sequence of driving the first drive electrical signals and the second drive electrical signals of two adjacent display rows is different. Definitely, the solutions in this embodiment are merely exemplary. Any variations based on this embodiment that does not require creative work all falls within the scope of protection of the present disclosure.

Specifically, in a case of the pixel values of the two adjacent sub-pixel points in the same display row respectively are the first pixel value and the second pixel value and the pixel values of the plurality of sub-pixel points in the same display column are the first pixel values or the second pixel values, the energy consumed accounts for about 90% of the maximum energy consumption; and in a case of the pixel values of the two adjacent sub-pixel points in the same display row respectively are the first pixel value and the second pixel value and the pixel values of the two adjacent sub-pixel points in the same display column respectively are the first pixel value and the second pixel value, the situation is more complicated, and the energy consumed is approximately equal to the maximum energy consumption.

Specifically, one pixel point includes three sub-pixel points. The three sub-pixel points correspond to the following three channels of a color image: a red channel, a green channel and a blue channel.

Specifically, the output electrical signal is a voltage signal or a current signal.

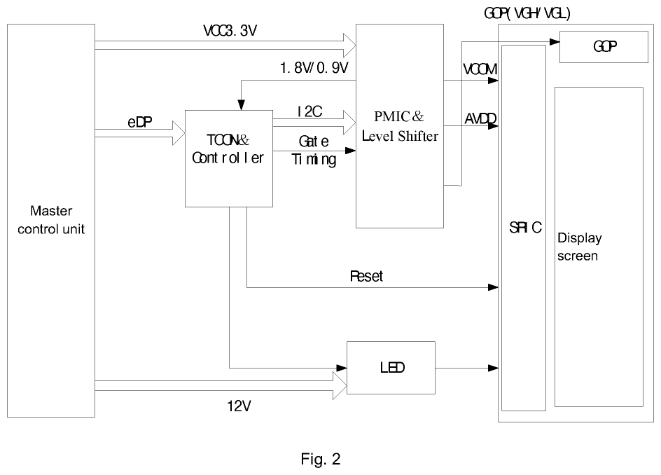

The present disclosure is applied to a device shown in FIG. 2. As shown in FIG. 2, the device includes a master control unit (HOST), a screen driver board (TCON), a control panel (Controller), a PMIC, a level shifter chip (Level Shifter), an LED, an SRIC, a GOP and a display screen, and specific connection relationships are shown in FIG. 2.

The present disclosure is applied to a power distribution solution shown in FIG. 3. The PMIC outputs a power supply of the screen driver board to the screen driver board, and outputs a power supply of a source driver chip to the source driver chip. The source driver chip is configured to drive the display screen to display. The PMIC outputs a power supply of the level shifter chip to the level shifter chip.

An embodiment of the present disclosure further provides a screen driver board. It is to be noted that, the screen driver board of this embodiment of the present disclosure may be configured to execute the method for adjusting an output electrical signal of a power management integrated circuit provided in the embodiments of the present disclosure. The screen driver board provided in this embodiment of the present disclosure is introduced below.

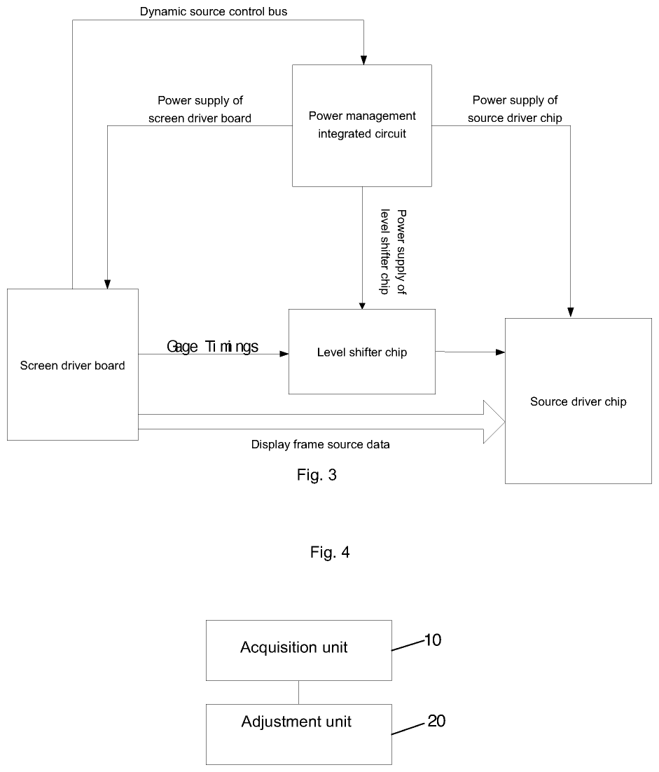

FIG. 4 is a schematic diagram of a screen driver board according to an embodiment of the present disclosure. As shown in FIG. 4, the screen driver board includes an acquisition component and an adjustment component.

The acquisition component 10 is configured to acquire display frame source data of frames displayed on a display module. The display frame source data at least includes a pixel value of each pixel point.

The adjustment component 20 is configured to adjust an output electrical signal of a PMIC according to the display frame source data. The output electrical signal is used for supplying power for a screen-related structure. The screen-related structure includes at least one of a screen driver board, a light-emitting structure and a level shifter chip.

In this solution, the acquisition component acquires the display frame source data of the frames displayed on the display module, and then the adjustment component adjusts the output electrical signal of the PMIC according to the display frame source data, the adaptability of the output electrical signal of the PMIC can be adjusted. Compared with a solution of outputting a fixed electrical signal, power consumption can be reduced.

In some embodiments of the present disclosure, the adjustment component includes a first adjustment component and a second adjustment component. The first adjustment component is configured to, in a case of the pixel values of all of the pixel points are the same pixel value, according to the pixel value, adjust the output electrical signal of the PMIC. The second adjustment component is configured to, in a case of the pixel values of all of the pixel points are not the same pixel value, according to the difference among the different pixel values, adjust the output electrical signal of the PMIC. That is to say, the output electrical signal of the PMIC is adjusted according to numerical value of the pixel value and changes in the pixel values. Therefore, insofar as guaranteeing a display effect, power consumption can be reduced.

In some other embodiments of the present disclosure, the first adjustment component includes at least one of a first adjustment sub-component, a second adjustment sub-component or a third adjustment sub-component. The first adjustment sub-component is configured to, in a case of the pixel values of all of the pixel points are minimum pixel values, adjust the output electrical signal to a first output electrical signal. The second adjustment sub-component is configured to, in a case of the pixel values of all of the pixel points are maximum pixel values, adjust the output electrical signal to a second output electrical signal. The third adjustment sub-component is configured to, in a case of the pixel values of all of the pixel points are intermediate pixel values, adjust the output electrical signal to a third output electrical signal. The intermediate pixel values are greater than the minimum pixel value and less than the maximum pixel value. The first output electrical signal is less than the third output electrical signal. The third output electrical signal is less than the second output electrical signal. For example, in a case of all of the pixel points are displayed in black, all of the pixel values are the minimum pixel values 0, and in this case, the display effect can be achieved by outputting a small first output electrical signal. In a case of all of the pixel points are displayed in white, all of the pixel values are the minimum pixel values 255, and in this case, the display effect can be achieved by outputting a large second output electrical signal. In a case of all of the pixel points are displayed in gray, all of the pixel values are the intermediate pixel values 100, and in this case, the display effect can be achieved by outputting an intermediate third output electrical signal. In conclusion, insofar as meeting the display effect, power consumption can be reduced.

In some other embodiments of the present disclosure, the second adjustment component includes at least one of a fourth adjustment sub-component or a fifth adjustment sub-component. The fourth adjustment sub-component is configured to, in a case of the pixel values of two adjacent display rows are successively first pixel values and second pixel values, adjust the output electrical signal of the PMIC to a first drive electrical signal in a case of a first display row is driven, and adjust the output electrical signal of the PMIC to a second drive electrical signal in a case of a second display row is driven. The pixel values of the pixel points in the first display row are the first pixel values, and the pixel values of the pixel points in the second display row are the second pixel values. For example, in a case of a row of black and a row of white are alternately displayed, the first drive electrical signal is used in a case of the black display row is driven, the second drive electrical signal is used in a case of the white display row is driven. Since the first drive electrical signal is different from the second drive electrical signal, level shifting is required to be performed. The fifth adjustment sub-component is configured to, in a case of the pixel values of two adjacent pixel points in the same display row respectively are the first pixel value and the second pixel value, alternately use the first drive electrical signal and the second drive electrical signal to drive the two adjacent pixel points in the same display row. For example, in a case of the same display row is displayed in black and white alternately, the first drive electrical signal is used in a case of the displayed black pixel points are driven, and the second drive electrical signal is used in a case of the displayed white pixel points are driven. Since the first drive electrical signal is different from the second drive electrical signal, level shifting is required to be performed.

In some other embodiments of the present disclosure, each pixel point includes a plurality of sub-pixel points. The adjustment component includes a third adjustment component. The third adjustment component is configured to adjust the output electrical signal of the PMIC according to the pixel values of the sub-pixel points in each pixel point. In order to adjust the output electrical signal of the PMIC more accurately, a parameter of sub-pixel point is taken into consideration.

In some other embodiments of the present disclosure, the third adjustment component is further configured to, in a case of the pixel values of the two adjacent sub-pixel points in the same display row respectively are a first pixel value and a second pixel value, alternately use a first drive electrical signal and a second drive electrical signal to drive the two adjacent sub-pixel points in the same display row. Therefore, insofar as guaranteeing the same display effect, power consumption can be reduced.

In some other embodiments of the present disclosure, the third adjustment component includes a sixth adjustment sub-component and a seventh adjustment sub-component. The sixth adjustment sub-component is configured to, in a case of the pixel values of the two adjacent sub-pixel points in the same display row respectively are the first pixel value and the second pixel value and the pixel values of the plurality of sub-pixel points in the same display column are the first pixel values or the second pixel values, alternately use the first drive electrical signal and the second drive electrical signal to drive the two adjacent sub-pixel points in the same display row. The sequence of driving the first drive electrical signal and the second drive electrical signal of all the display rows is the same. The seventh adjustment sub-component is configured to, in a case of the pixel values of the two adjacent sub-pixel points in the same display row respectively are the first pixel value and the second pixel value and the pixel values of the two adjacent sub-pixel points in the same display column respectively are the first pixel value and the second pixel value, alternately use the first drive electrical signal and the second drive electrical signal to drive the two adjacent sub-pixel points in the same display row. The sequence of driving the first drive electrical signals and the second drive electrical signals of two adjacent display rows is different.

The screen driver board includes a processor and a memory. The acquisition component and the adjustment component are all stored in the memory as program units. The processor executes the program units stored in the memory to implement corresponding functions.

The processor includes a kernel, and the kernel invokes the corresponding program units from the memory. There may be one or more kernels arranged. Power consumption is reduced by adjusting kernel parameters.

The memory may include a non-persistent memory in a computer-readable medium, a Random Access Memory (RAM) and/or a non-volatile memory, for example, a Read Only Memory (ROM) or a flash memory (flash RAM). The memory includes at least one memory chip.

An embodiment of the present disclosure provides a computer-readable storage medium. The computer-readable storage medium includes a stored program. In a case of the program is operated, a device where the computer-readable storage medium is located is controlled to execute the method for adjusting an output electrical signal of a power management integrated circuit.

An embodiment of the present disclosure provides a processor. The processor is configured to operate a program. The method for adjusting an output electrical signal of a power management integrated circuit is executed in a case of the program is operated.

An embodiment of the present disclosure provides an electronic device. The electronic device includes one or more processors, a memory, and one or more programs. The one or more programs are stored in the memory, and are configured to be executed by the one or more processors. The one or more programs instructions that are configured to execute the method described in any one of the above.

An embodiment of the present disclosure provides a device. The device includes a processor, a memory, and a program stored on the memory and executable on the processor. The processor, in a case of executing the program, implements at least the following steps.

At S101, display frame source data of frames displayed on a display module is acquired. The display frame source data at least includes a pixel value of each pixel point.

At S102, an output electrical signal of a PMIC is adjusted according to the display frame source data. The output electrical signal is used for supplying power for a screen-related structure. The screen-related structure includes at least one of a screen driver board, a light-emitting structure and a level shifter chip.

The device herein may be a server, a PC, a PAD, a mobile phone, or the like.

The present disclosure further provides a computer program product. In a case of being executed on a data processing device, the computer program product is adapted to execute a program initialized with at least the following method steps.

At S101, display frame source data of frames displayed on a display module is acquired. The display frame source data at least includes a pixel value of each pixel point.

At S102, an output electrical signal of a PMIC is adjusted according to the display frame source data. The output electrical signal is used for supplying power for a screen-related structure. The screen-related structure includes at least one of a screen driver board, a light-emitting structure and a level shifter chip.

Persons skilled in the art should understand that the embodiments of the present disclosure may be provided as a method, a system, or a computer program product. Therefore, the present disclosure may adopt forms of complete hardware embodiments, complete software embodiments or embodiments integrating software and hardware. Moreover, the present disclosure may adopt the form of a computer program product implemented on one or more computer available storage media (including but being not limited to a disk memory, a Compact Disc Read Only Memory (CD-ROM), an optical memory, and the like) containing computer available program codes.

The present disclosure is described with reference to flowcharts and/or block diagrams of the method, the device (system) and the computer program product according to the embodiments of the present disclosure. It should be understood that each flow and/or block in the flowchart and/or block diagram, and the combination of the flow and/or block in the flowchart and/or block diagram can be implemented by the computer program instructions. These computer program instructions can be provided to a processor of a general-purpose computer, a special-purpose computer, an embedded processor or other programmable data processing devices to generate a machine, so that instructions which are executed by the processor of the computer or other programmable data processing devices generate a device which is used for implementing the specified functions in one or more flows of the flowchart and/or one or more blocks of the block diagram.

These computer program instructions may also be stored in the computer-readable memory which can guide the computer or other programmable data processing devices to work in a particular way, so that the instructions stored in the computer-readable memory generate a product including an instruction device. The instruction device implements the specified functions in one or more flows of the flowchart and/or one or more blocks of the block diagram.

These computer program instructions may also be loaded on the computer or other programmable data processing devices, so that a series of operation steps are performed on the computer or other programmable data processing devices to generate the processing implemented by the computer, and the instructions executed on the computer or other programmable data processing devices provide the steps for implementing the specified functions in one or more flows of the flowchart and/or one or more blocks of the block diagram.

In a typical configuration, a computing device includes one or more processors (CPUs), an input/output interface, a network interface, and an internal memory.

The memory may include a non-persistent memory in a computer-readable medium, a Random Access Memory (RAM) and/or a non-volatile memory, for example, a Read Only Memory (ROM) or a flash memory (flash RAM). The memory is an example of the computer-readable medium.

The computer-readable medium includes both persistent and non-permanent, removable and non-removable media, and may achieve information storage by any method or technology. The information may be a computer-readable instruction, a data structure, a module of a program, or other data. Examples of a computer storage medium include but are not limited to a Phase Change Memory (PRAM), a Static Random Access Memory (SRAM), a Dynamic Random Access Memory (DRAM), other types of Random Access Memories (RAM), a Read-Only Memory (ROM), an Electrically Erasable Programmable Read-Only Memory (EEPROM), a flash memory or other memory technologies, a Compact Disk Read-Only Memory (CD-ROM), a Digital Versatile Disc (DVD) or other optical storages, a cartridge storage, a magnetic tape disk storage or other magnetic storage devices or any other non-transmitting medium that may be configured to store information accessible by a computing device. According to the definition herein, the computer-readable medium does not include transitory computer-readable media, such as modulated data signals and carriers.

It is also to be noted that, terms “comprise”, “include” or any other variants are intended to encompass non-exclusive inclusion, such that a process, a method, a commodity, or a device including a series of elements not only include those elements, but also includes other elements not listed explicitly or includes intrinsic elements for the process, the method, the commodity, or the device. Without any further limitation, an element defined by the phrase “comprising one” does not exclude existence of other same elements in the process, the method, the commodity, or the device that includes the elements.

It may be seen from the above description that, in the above embodiments of the present disclosure, the following technical effects are realized.
1) According to the method for adjusting an output electrical signal of a power management integrated circuit of the present disclosure, by means of acquiring the display frame source data of the frames displayed on the display module, and then adjusting the output electrical signal of the PMIC according to the display frame source data, the adaptability of the output electrical signal of the PMIC can be adjusted. Compared with a solution of outputting a fixed electrical signal, power consumption can be reduced.
2) According to the screen driver board of the present disclosure, the acquisition component acquires the display frame source data of the frames displayed on the display module, and then the adjustment component adjusts the output electrical signal of the PMIC according to the display frame source data, the adaptability of the output electrical signal of the PMIC can be adjusted. Compared with a solution of outputting a fixed electrical signal, power consumption can be reduced.

The above are only the preferred embodiments of the invention and are not intended to limit the invention. For those skilled in the art, the invention may have various modifications and variations. Any modifications, equivalent replacements, improvements and the like made within the spirit and principle of the invention shall fall within the scope of protection of the invention.

What is claimed is:

1. A method for adjusting an output electrical signal of a power management integrated circuit, comprising:
acquiring display frame source data of frames displayed on a display module, wherein the display frame source data at least comprises a pixel value of each pixel point; and
adjusting an output electrical signal of a Power Management Integrated Circuit (PMIC) according to the display frame source data, wherein the output electrical signal is used for supplying power for a screen-related structure, and the screen-related structure comprises at least one of a screen driver board, a light-emitting structure and a level shifter chip.

2. The method according to claim 1, wherein adjusting the output electrical signal of the PMIC according to the display frame source data comprises:
in a case of the pixel values of all of the pixel points are the same pixel value, adjusting the output electrical signal of the PMIC according to the numerical value of the pixel value; and
in a case of the pixel values of all of the pixel points are not the same pixel value, adjusting the output electrical signal of the PMIC according to the difference among the different pixel values.

3. The method according to claim 2, wherein in a case of the pixel values of all of the pixel points are the same pixel value, adjusting the output electrical signal of the PMIC according to the numerical value of the pixel value comprises at least one of the following:
in a case of the pixel values of all of the pixel points are minimum pixel values, adjusting the output electrical signal to a first output electrical signal;
in a case of the pixel values of all of the pixel points are maximum pixel values, adjusting the output electrical signal to a second output electrical signal; or
in a case of the pixel values of all of the pixel points are intermediate pixel values, adjusting the output electrical signal to a third output electrical signal, wherein the intermediate pixel values are greater than the minimum pixel value and less than the maximum pixel value, the first output electrical signal is less than the third output electrical signal, and the third output electrical signal is less than the second output electrical signal.

4. The method according to claim 2, wherein in a case of the pixel values of all of the pixel points are not the same pixel value, adjusting the output electrical signal of the PMIC according to the difference among the different pixel values comprises at least one of the following:
in a case of the pixel values of two adjacent display rows are successively first pixel values and second pixel values, adjusting the output electrical signal of the PMIC to a first drive electrical signal in a case of a first display row is driven, and adjusting the output electrical signal of the PMIC to a second drive electrical signal in a case of a second display row is driven, wherein the pixel values of the pixel points in the first display row are the first pixel values, and the pixel values of the pixel points in the second display row are the second pixel values; and
in a case of the pixel values of two adjacent pixel points in the same display row respectively are the first pixel value and the second pixel value, alternately using the first drive electrical signal and the second drive electrical signal to drive the two adjacent pixel points in the same display row.

5. The method according to claim 1, wherein each pixel point comprises a plurality of sub-pixel points;
and adjusting the output electrical signal of the PMIC according to the display frame source data comprises:
adjusting the output electrical signal of the PMIC according to the pixel values of the sub-pixel points in each pixel point.

6. The method according to claim 5, wherein adjusting the output electrical signal of the PMIC according to the pixel values of the sub-pixel points in each pixel point comprises:
in a case of the pixel values of the two adjacent sub-pixel points in the same display row respectively are a first pixel value and a second pixel value, alternately using a first drive electrical signal and a second drive electrical signal to drive the two adjacent sub-pixel points in the same display row.

7. The method according to claim 6, wherein in a case of the pixel values of the two adjacent sub-pixel points in the same display row respectively are the first pixel value and the second pixel value, alternately using the first drive electrical signal and a second drive electrical signal to drive the two adjacent sub-pixel points in the same display row comprises:
in a case of the pixel values of the two adjacent sub-pixel points in the same display row respectively are the first pixel value and the second pixel value and the pixel values of the plurality of sub-pixel points in the same display column are the first pixel values or the second pixel values, alternately using the first drive electrical signal and the second drive electrical signal to drive the two adjacent sub-pixel points in the same display row, wherein the sequence of driving the first drive electrical signal and the second drive electrical signal of all the display rows is the same; and
in a case of the pixel values of the two adjacent sub-pixel points in the same display row respectively are the first pixel value and the second pixel value and the pixel values of the two adjacent sub-pixel points in the same display column respectively are the first pixel value and the second pixel value, alternately using the first drive electrical signal and the second drive electrical signal to drive the two adjacent sub-pixel points in the same display row, wherein the sequence of driving the first drive electrical signals and the second drive electrical signals of two adjacent display rows is different.

8. The method according to any of claims 5 to 7, wherein one pixel point comprises three sub-pixel points.

9. The method according to any of claims 1 to 7, wherein the output electrical signal is a voltage signal or a current signal.

10. A screen driver board, comprising:
an acquisition component, configured to acquire display frame source data of frames displayed on a display module, wherein the display frame source data at least comprises a pixel value of each pixel point; and
an adjustment component, configured to adjust an output electrical signal of a Power Management Integrated Circuit (PMIC) according to the display frame source data, wherein the output electrical signal is used for supplying power for a screen-related structure, and the screen-related structure comprises at least one of a screen driver board, a light-emitting structure and a level shifter chip.

11. An electronic device, comprising one or more processors, a memory, and one or more programs, wherein the one or more programs are stored in the memory, and are configured to be executed by the one or more processors; and the one or more programs instructions that are configured to execute the method according to any of claims 1 to 9.
